(19) United States
(12) Patent Application Publication
(10) Pub. No.: US 2003/0008079 A1
(43) Pub. Date: Jan. 9, 2003

(54) Waterborne coating compostion and process of producing a film having improved adhesion on a substrate

(76) Inventor: Keith L. Salter, (US)

Correspondence Address: BASF CORPORATION, ANNE GERRY SABOURIN, 26701 TELEGRAPH ROAD, SOUTHFIELD, MI, 48034-2442, US

(21) Appl. No.: 09/865,139

(22) Filed: May 24, 2001

(51) Int. Cl. B05D 3/02

(52) U.S. Cl. 427/421; 427/385.5

(57) ABSTRACT

A waterborne coating composition and a process of producing a film having improved adhesion on a substrate are disclosed. The waterborne coating composition, preferably a waterborne basecoat, includes a first component and a second component. The first component includes a solvent-based polyurethane and a neutralizing agent, preferably an amine. The polyurethane has hydroxyl functional groups and acid functional groups. The amine neutralizes the acid functional groups. As a result, an ammonium ion and a salt of the polyurethane are formed. The salt of the polyurethane, including a carboxylate ion, establishes dispersibility of the polyurethane in water. The second component includes a water-based epoxy resin. The water-based epoxy resin is substantially free of co-solvents and includes an epoxide group that is reactive with the ammonium ion. The first and second components of the waterborne coating composition produce the film having improved adhesion on the substrate of from 0 to 10 percent film loss according to a cross-hatch adhesion test.

### FIELD OF THE INVENTION

The subject invention generally relates to a waterborne coating composition and a process of producing a film having improved adhesion on a substrate. More specifically, the waterborne coating composition of the subject invention includes a first component having a water-dispersed polyurethane and a second component having a water-based epoxy resin that produce a film having improved adhesion on the substrate of from 0 to 10 percent film loss according to a cross-hatch adhesion test.

### BACKGROUND OF THE INVENTION

Waterborne coating compositions, specifically waterborne basecoat compositions, are known in the art. In both the refinish and original equipment manufacturer (OEM) coating industries, waterborne basecoat compositions are applied to a substrate, such as an automobile body, to produce a film on the substrate. Such films serve both functional and aesthetic purposes.

Many of these waterborne basecoat compositions incorporate a solvent-based polyurethane as a primary binder resin. To effectively disperse the polyurethane resin in water, the waterborne basecoat compositions incorporate a neutralizing agent such as an amine. Amines neutralize certain functional groups associated with the polyurethane to form salts of the polyurethane. The salts of the polyurethane promote dispersibility of the polyurethane in water. These polyurethanes are known in the art as amine dispersible polyurethane resins.

It is generally understood that amine dispersible polyurethane resins are ‘sensitive’ to water. Furthermore, because these amine dispersible polyurethane resins are the primary binder resin for many waterborne basecoat compositions, the films produced by such compositions are also sensitive to water, and are therefore susceptible to many water-related defects. These water-related defects that affect the films produced by the waterborne coating compositions include poor adhesion of the film on the substrate, inter-film adhesion failure, film swelling, and film blistering. Ultimately these defects lead to unsatisfactory chip performance and even to complete delamination of the film from the substrate.

For many reasons, the refinish and OEM coating industries are anxious to remedy the water-related defects associated with the films produced by waterborne coating compositions that utilize amine dispersible polyurethane resins. For example, waterborne coating compositions are being used more frequently due to environmental concerns. Therefore, an increasing number of automobiles have films produced by waterborne coating compositions that utilize amine dispersible polyurethane resins. The refinish and OEM coating industries are also seeking to improve upon these water-related defects as the films produced by these waterborne coating compositions are commonly exposed to water due to rain, snow, and other inclement weather conditions.

In sum, the waterborne coating compositions utilizing amine dispersible polyurethane resins, as described above, are characterized by one or more inadequacy. Due to the inadequacies identified in the prior art, it is desirable to provide a novel waterborne coating composition that is not sensitive to attack by water such that films produced by the waterborne coating composition are resistant to the water-related defects described above, such as the poor adhesion of the film on the substrate.

### SUMMARY OF THE INVENTION

A waterborne coating composition and a process of producing a film of the waterborne coating composition are disclosed. The composition and process produce a film having improved adhesion on a substrate. More specifically, the composition and process produce the film to have improved adhesion on the substrate of from 0 to 10 percent film loss according to a cross-hatch adhesion test.

The waterborne coating composition includes a first component (A) and a second component (B). The first component (A) comprises a solvent-based polyurethane and a neutralizing agent, preferably an amine. The polyurethane includes at least one hydroxyl functional group and at least one acid functional group. The neutralizing agent neutralizes the at least one acid functional group of the polyurethane thereby forming an ammonium ion and a salt of the polyurethane. The salt of the polyurethane has at least one carboxylate ion establishing dispersibility of the polyurethane in water. As such, the solvent-based polyurethane is an amine dispersible polyurethane resin as described above.

The second component (B) comprises a water-based epoxy resin. The water-based epoxy resin is substantially free of co-solvents. The water-based epoxy resin includes at least one epoxide group that is reactive with the ammonium ion formed during the neutralization in the first component (A). This reaction between the ammonium ion and the at least one epoxide group enables the film of the waterborne coating composition to achieve the improved adhesion of from 0 to 10 percent film loss. Adhesion of from 0 to 10 percent film loss is sufficient for the waterborne coating composition to not be sensitive to attack by water. Furthermore, this adhesion is also sufficient for films of the waterborne coating composition to be resistant to the various water-related defects set forth above, such as poor adhesion of the film to the substrate.

In addition to the first (A) and second (B) components, the waterborne coating composition preferably includes a binder-free, reduction agent (C). The binder-free, reduction agent (C) includes water that reduces a viscosity of the first (A) and second (B) components to establish a reduced waterborne coating composition. The waterborne coating composition also preferably includes at least one pigment as well as other performance enhancing additives, such as rheology control additives and flow and appearance control agents. The type and amount of pigments and performance enhancing additives are included in the waterborne coating composition depending on customer requirements.

In addition to providing the waterborne coating composition, the process of the subject invention also includes the step of reducing the waterborne coating composition to establish the reduced waterborne coating composition, and the step of applying, specifically spraying, the reduced waterborne coating composition on to the substrate.

Accordingly, the subject invention provides a novel waterborne coating composition, utilizing an amine dispersible polyurethane resin, and a process of producing a film of the waterborne coating composition to have improved adhesion on a substrate such that the film of the waterborne coating composition is resistant to water-related defects, including the water-related defect of poor adhesion of the film on the substrate.

### DETAILED DESCRIPTION OF THE INVENTION

The waterborne coating composition of the subject invention produces a film having improved adhesion on a substrate. Specifically, the waterborne coating composition includes first (A) and second (B) components that produce the film that has improved adhesion on the substrate of from 0 to 10 percent film loss according to a cross-hatch adhesion test. The details of the cross-hatch adhesion test will be described in detail below. Although the waterborne coating composition is preferably applied to form the film on a metallic substrate such as an automobile body, the waterborne coating composition may be applied to other substrates without varying the scope of the subject invention. By way of example, the waterborne coating composition of the subject invention may be applied to a plastic substrate such as a bumper, mirror, or internal dashboard, of the automobile. The waterborne coating composition may also be applied to aluminum and galvanized steel.

The first component (A) of the waterborne coating composition includes a solvent-based polyurethane and a neutralizing agent. The solvent-based polyurethane includes at least one hydroxyl functional group and at least one acid functional group. As will be described below, the acid functional group of the polyurethane is neutralized by the neutralizing agent. An ammonium ion and a salt of the polyurethane are formed as a result of the neutralization of the acid functional group by the amine. The salt of the polyurethane has at least one carboxylate ion and establishes the dispersibility of the polyurethane in water. As such, the solvent-based polyurethane is an amine dispersible polyurethane resin. However, it is to be understood that, even after the acid functional group of the polyurethane has been neutralized, the polyurethane remains solvent-based until a reduction agent (C) which includes water is introduced such that the polyurethane is thereafter suitably dispersed in water. The reduction agent (C) will be described more below.

Preferably, the solvent-based polyurethane is prepared by reacting isocyanate (NCO)-containing prepolymers with compounds that are reactive toward the isocyanate. Preparation of the isocyanate-containing prepolymers can be carried out by reaction of polyols having a hydroxyl number of from 10 to 1800, preferably from 50 to 1200 mg of KOH/g, with excess polyisocyanates at temperatures of up to 150° C., preferably from 50 to 130° C., in organic solvents which are not able to react with the isocyanates. The ratio of equivalents of NCO to OH groups is between 2.0:1.0 and 1.0:1.0, preferably between 1.4:1 and 1.1:1. The isocyanate-containing prepolymers contain at least about 0.5% by weight of NCO, preferably at least 1% by weight of NCO, based on the solids content. The upper limit is about 15% by weight, preferably 10% by weight, particularly preferably 5% by weight of NCO.

The polyols employed for the preparation of the isocyanate-containing prepolymers may be of low molecular weight and/or high molecular weight and may contain slow-to-react anionic groups or groups capable of forming anions. It is also possible to use low molecular weight polyols having a molecular weight of from 60 up to 400 in order to prepare the isocyanate-containing prepolymers. In this case, quantities of up to 30% by weight of the overall polyol components, preferably from about 2 to 20% by weight, are employed.

In order to obtain the isocyanate-containing prepolymer of high flexibility, a high proportion of a predominantly linear polyols should be added, having a preferred hydroxyl number of from 30 to 150 mg of KOH/g. Up to 97% by weight of the overall polyol may be composed of saturated and unsaturated polyesters and/or polyethers having a molecular mass Mn of from 400 to 5000. The polyetherdiols selected should not introduce any excessive quantities of ether groups, since otherwise the polymers formed swell in water. Polyester diols are prepared by esterification of organic dicarboxylic acids or anhydrides thereof with organic diols, or are derived from a hydroxycarboxylic acid or a lactone. In order to prepare branched polyester polyols it is possible to employ to a minor extent polyols or polycarboxylic acids having a relatively high functionality.

Preferably, the alcohol component employed for preparation of the solvent-based polyurethane comprises at least one first diol of the following formula;

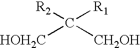

in which R₁ and R₂ are each an identical or different radical and are an alkyl radical of 1 to 18 carbon atoms, an aryl radical or a cycloaliphatic radical, with the proviso that R₁ and/or R₂ may not be methyl, and/or at least one second diol of the following formula;

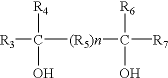

R₃, R₄, R₆ and R₇ are each identical or different radicals and are an alkyl radical of 1 to 6 carbon atoms, a cycloalkyl radical or an aryl radical, and R₅ is an alkyl radical of 1 to 6 carbon atoms, an aryl radical or an unsaturated alkyl radical of 1 to 6 carbon atoms, and n is either 0 or 1.

As the at least one first diol, suitable propanediols are all those in which either R₁ or R₂, or R₁ and R₂, is not methyl such as 2-butyl-2-ethylpropane-1,3-diol, 2-phenyl-2-methylpropane-1,3-diol, 2-propyl-2-ethylpropane-1,3-diol, 2-di-tert-butylpropane-1,3-diol, 2-butyl-2-propylpropane-1,3-diol, 1-dihydroxymethyl-bicyclo [2.2.1] heptane, 2,2-diethyl-propane-1,3-diol, 2,2-dipropylpropane-1,3-diol, 2-cyclohexyl-2-methylpropane-1 ,3-diol, and equivalents thereof.

As the at least one second diol, it is possible to employ, for example, 2,5-dimethylhexane-2,5-diol, 2,5-diethyl-hexane-2,5-diol, 2-ethyl-5-methylhexane-2,5-diol, 2,4-dimethylpentane-2,4-diol, 2,3-dimethylbutane-2,3-diol, 1,4-(2′-hydroxypropyl)benzene, and 1,3-(2′-hydroxypropyl) benzene, and equivalents thereof.

As the at least one first diol, it is preferred to employ, 2-propyl-2-ethylpropane-1,3-diol, 2,2-diethylpropane-1,3-diol, 2-butyl-2-ethylpropane-1,3-diol and 2-phenyl-2-ethyl-propane-1,3-diol. As the at least one second diol, it is preferred to employ 2,3-dimethylbutane-2,3-diol and 2,5-dimethylhexane-2,5-diol. It is particularly preferred to employ, 2-butyl-2-ethylpropane-1,3-diol and 2-phenyl-2-ethylpropane-1,3-diol as the at least one first diol, and 2,5-dimethylhexane-2,5-diol as the at least one second diol. The at least one first and second diols are customarily employed in a quantity of from 0.5 to 15% by weight, preferably from 1 to 7% by weight, based in each case on the overall weight of synthesis components employed for the preparation of the solvent-based polyurethane.

Multifunctional isocyanates may also be used for preparation of the solvent-based polyurethane. In such a case, use is made of aliphatic, cycloaliphatic and/or polyisocyanates having at least two isocyanate groups per molecule. Isomers or isomer mixtures of organic diisocyanates are most preferred in these cases. Due to good resistance to ultraviolet light, (cyclo)aliphatic diisocyanates give rise to films with a low tendency toward yellowing, a tendency which is highly desirable.

The polyisocyanate component used to form the isocyanate-containing prepolymer may also contain a proportion of more highly functional polyisocyanates, provided that this does not cause any gelling of the polyurethane and ultimately of the waterborne coating composition. Triisocyanates which have proven suitable are products formed by trimerization or oligomerization of diisocyanates or by reaction of diisocyanates with polyfunctional OH- or NH-containing compounds. Finally, average functionality may be lowered, if desired, by addition of monoisocyanates.

Examples of polyisocyanates which can be employed are phenylene diisocyanate, toluylene diisocyanate, xylylene diisocyanate, bisphenylene diisocyanate, naphthylene diisocyanate, diphenylmethane diisocyanate, isophorone diisocyanate, cyclobutane diisocyanate cyclopentylene diisocyanate, cyclohexylene diisocyanate, methylcyclohexylene diisocyanate, dicyclohexylmethane diisocyanate, ethylene diisocyanate, trimethylene diisocyanate, tetramethylene diisocyanate, pentamethylene diisocyanate, hexamethylene diisocyanate, propylene diisocyanate, ethylethylene diisocyanate and trimethylhexane diisocyanate.

For the preparation of high-solids polyurethane solutions, use is made in particular of diisocyanates having the following general formula;

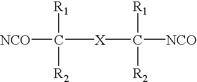

in which X is a divalent, aromatic hydrocarbon radical, preferably an optionally halogen-, methyl- or methoxy-diphenylene or 1,2-, 1,3- or 1,4-phenylene radical, particularly preferably a 1,3-phenylene radical, and R₁ and R₂ are an alkyl radical of 1-4 carbon atoms, preferably a methyl radical. Diisocyanates of this formula are known (their preparation is described, for example, in EP-A-101 832, U.S. Pat. No. 3,290,350, U.S. Pat. No. 4,130,577, and U.S. Pat. No. 4,439,616) and some are obtainable commercially (1,3-bis(2-isocyanatoprop-2-yl)benzene, for example, is sold by the American Cyanamid Company under the trade name TMXDI (META)®)).

It is preferred to employ a solvent-based polyurethane which, as a 50% strength solution in ethoxyethyl propionate, has a viscosity at 23° C. of #5.0 dPa.s, preferably a viscosity of #3.5 dpa.s. The solvent-based polyurethane is generally not compatible with water unless, in the course of its synthesis, specific constituents are incorporated and/or particular preparation steps are undertaken. Thus, for the preparation of the polyurethane, it is possible to use compounds, which contain two H-active groups, which are reactive with isocyanate groups, and at least one group, which ensures dispersibility in water. Suitable groups that ensure dispersibility of the polyurethane in water are nonionic groups (e.g. polyethers), anionic groups, mixtures of these two groups, or cationic groups.

It is thus possible to incorporate into the polyurethane an acid number, which is sufficient for the neutralized product to give a stable dispersion in water. Compounds used for this purpose contain at least one group, which is reactive toward isocyanate groups, the hydroxyl functional group of the solvent-based polyurethane, and at least one group which is capable of forming anions, the acid functional group of the solvent-based polyurethane. More specifically, suitable groups that are reactive toward isocyanate groups are, in particular, the hydroxyl group and primary and/or secondary amino groups. Groups capable of forming anions are acid functional groups (i.e., carboxylic acid functional groups or carboxyl groups), sulfonic acid and/or phosphoric acid groups. Preference is given to the employment of alkanoic acids having two substituents on the α carbon atom. The substituent may be a hydroxyl group, an alkyl group or an alkylol group. These polyols have at least one, generally from 1 to 3, carboxyl groups in the molecule. They have from two to about 25, preferably from 3 to 10, carbon atoms. The carboxyl group-containing polyol may make up from 3 to 100% by weight, preferably from 5 to 50% by weight, of the overall polyol constituent in the isocyanate-containing prepolymer.

The quantity of ionizable carboxyl groups which is available in salt form owing to the neutralization of the carboxyl groups is generally at least 0.4% by weight, preferably at least 0.7% by weight, based on the solids content. The upper limit is about 12% by weight. The quantity of dihydroxyalkanoic acids in the un-neutralized isocyanate-containing prepolymer gives rise to an acid number of at least 5, preferably at least 10. In the case of very low acid numbers, further measures are generally necessary in order to achieve dispersibility in water. The acid number of the polyurethane of the first component (A) is from 5 to 150 mg KOH/g. In the preferred embodiment of the subject invention, the acid number preferably ranges from 10 to 40 mg of KOH/g. Most preferably, the acid number of the polyurethane is from 20 to 30 mg of KOH/g.

The isocyanate groups of the isocyanate-containing prepolymer are preferably reacted with a modifying agent. In this context, the modifying agent is added in a quantity such that chain extensions, and thus increases in molecular weight, occur. Preferred modifying agents are organic compounds containing hydroxyl and/or secondary and/or primary amino groups, in particular di-, tri- and/or more highly functional polyols. Examples of polyols, which can be employed, are trimethylolpropane, 1,3,4 butanetriol, glycerol, erythritol, mesoerythritol, arabitol, adonitol, and equivalents thereof. It is most preferred to employ trimethylolpropane.

In order to prepare the polyurethane resin according to the invention it is preferred first of all to prepare the isocyanate-containing prepolymer from which the desired polyurethane is then prepared by further reaction, preferably chain extension. Examples of the preparation of the prepolymers are described in DE-A 26 24 442 and DE-A 32 10 051. Examples of suitable polyurethane resins are described in the following documents: EP-A-355 433, DE-A-35 45 618, DE-A-38 13 866, DE-A-32 10 051, DE-A-26 24 442, DE-A-37 39 332, U.S. Pat. No. 4,719,132, EP-A-89 497, U.S. Pat. No. 4,558,090, U.S. Pat. No. 4,489,135, DE-A-36 28 124, EP-A-158 099, DE-A-29 26 584, EP-A-195 931, DE-A-33 21 180 and DE-A-40 05 961.

Overall, the solvent-based polyurethane of the first component (A) includes a number-average molecular weight of from 1,000 to 30,000, a weight-average molecular weight of from 5,000 to 50,000, and a hydroxyl number of from 10 to 200 mg KOH/g. In the preferred embodiment of the subject invention, the polyurethane includes a number-average molecular weight of from 3,000 to 15,000, a weight-average molecular weight of from 10,000 to 30,000, and a hydroxyl number of from 10 to 50 mg KOH/g.

In the context of only the first component (A) and the second component (B), i.e., an unreduced waterborne coating composition, the first component (A) is present in an amount of from 65 to 90, preferably from 75 to 80, parts by weight based on 100 parts by of the unreduced waterborne coating composition. The polyurethane is present in the first component (A) in an amount from 15 to 50, preferably from 20 to 40, parts by weight based on 100 parts by weight of the first component (A). In addition to the polyurethane, the first component (A) may further include at least one organic, water-dilutable solvent. Suitable organic, water-dilutable solvents include, but are not limited to, ethylene glycol monobutyl ether, sec-butyl alcohol, ethoxyethyl propionate, isopropoxypropanol, and methoxybutanol. Other solvents that may be utilized include SC 100 solvent (Solvesso 100) and ethanol. If included, the organic, water-dilutable solvent is present in the first component (A) in an amount from 30 to 60, preferably from 40 to 50, parts by weight based on 100 parts by weight of the first component (A).

The first component (A) may also comprise at least one pigment present in an amount from 5 to 50 parts by weight based on 100 parts by weight of the first component (A). The at least one pigment can include any pigment that is customarily employed in waterborne coating compositions. The pigment preferably does not react with water and/or does not dissolve in water. The pigment may consist of inorganic or organic compounds and may impart a special effect and/or color to the film of the waterborne coating composition. Special effect pigments that may be utilized include metal flake pigments, such as commercial aluminum bronzes, and also non-metallic effect pigments such as pearlescent or interference pigments. Examples of suitable inorganic color-imparting pigments include titanium dioxide, iron oxides, and carbon black. Examples of suitable organic color-imparting pigments include indanthrene blue, cromophthal red, irgazine orange, and heliogen green. It is to be understood that the amount of pigment present in the waterborne coating composition varies depending on many compositional factors including, but not limited to, a particular color family.

The first component (A) may also include at least one additive. The additive is selected from the group consisting of surfactants, fillers such as extender pigment, catalysts such as acid-based catalysts, flow and appearance control agents, rheology control additives, UV-resistant additives, defoaming additives. Of course, combinations of the above-referenced additives are suitable for the waterborne coating composition. As one example, the first component may include cross-linked polymeric microparticles such as inorganic phyllosilicates as the rheology control additive. Also, in addition to the solvent-based polyurethane, the first component (A) may also include other binder resins including, but not limited to, acrylate copolymers and polyester resins.

As stated above, the neutralizing agent included in the first component (A) neutralizes the acid functional group of the polyurethane. The neutralizing agent is preferably ammonia or an amine. The neutralizing agent includes, but is not limited to, trimethylamine, triethylamine, tributylamine, dimethylaniline, diethylaniline, triphenylamine, dimethylethanolamine, diethylethanolamine, methyldiethanolamine, triethanolamine, and the like. The amine selected for use in the preferred embodiment of the subject invention is dimethylethanolamine, (CH₃)₂NCH₂CH₂OH. In the neutralization of the acid functional group, the ammonium ion and the salt of the polyurethane are formed. In the context of the subject invention, the ammonium ion is defined as a nitrogen atom bearing four substituents that is positively charged. For example, in terms of the preferred embodiment utilizing dimethylethanolamine, the dimethylethanolamine pulls a hydrogen atom from the acid functional group of the polyurethane (—COOH) and the ammonium ion is represented in the following formula (CH₃)₂N⁺(H)(CH₂)CH₂OH. The hydrogen atom is thereafter associated with the ammonium ion. The neutralization of the acid functional group may take place in either the organic or the aqueous phase. The salt of the polyurethane is also formed as a result of this neutralization. The salt of the polyurethane has at least one carboxylate ion (COO⁻). The carboxylate ion is compatible with water and establishes the dispersibility of the polyurethane in water.

The second component (B) of the waterborne composition includes an epoxy resin. The epoxy resin is water-based and is substantially free of co-solvents. In the context of the subject invention, it is to be generally understood that substantially free of co-solvents is intended to indicate that the epoxy resin contributes less than 250 grams per liter of volatile organic compounds (VOCs) to the waterborne coating composition. As understood by one skilled in the art, VOCs are volatile chemical compounds that contain the element carbon, excluding certain common exempted chemical compounds such as methane, carbon monoxide, carbon dioxide, carbonic acid, and the like. In the event that the epoxy resin of the second component (B) includes a co-solvent, the preferred co-solvent is methoxypropanol. Although the epoxy resin is water-based, the second component (B) may optionally incorporate a surfactant to further enhance compatibility between the epoxy resin and water without the aid of co-solvents. A suitable surfactant is Surfynol 104 commercially available from Air Products under their Surfynol Surfactant product line.

The water-based epoxy resin includes at least one epoxide group reactive with the ammonium ion of the first component (A). As understood by those skilled in the art, the epoxide group, i.e., an epoxy ring, of the following general formula;

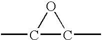

includes a central oxygen atom. The hydrogen atom of the ammonium ion, formed as a result of the neutralization of the solvent-based polyurethane by the neutralizing agent, reacts with the central oxygen atom of the epoxide group. More specifically, the hydrogen atom leaves the ammonium ion and opens the epoxy ring thereby forming an ester of the polyurethane and of the water-based epoxy resin.

The water-based epoxy resin of the second component (B) includes an epoxy equivalent weight of from 500 to 1500 g/mol according to DIN 53188, and a number-average molecular weight of from 500 to 3,000. In the preferred embodiment of the subject invention, the epoxy equivalent weight of the water-based epoxy resin is from 800 to 1200 g/mol, and the number-average molecular weight is from 750 to 1500.

In the context of only the first component (A) and the second component (B), i.e., the unreduced waterborne coating composition, the second component (B) is present in an amount of from 10 to 35, preferably from 15 to 20, parts by weight based on 100 parts by of the unreduced waterborne coating composition. The water-based epoxy resin is present in the second component (B) in an amount from 30 to 60, preferably from 40 to 50, parts by weight based on 100 parts by weight of the second component (B). Furthermore, the second component (B) is present in an amount from 10 to 50, preferably from 15 to 25, parts by weight based on 100 parts by weight of the first component (A). Put in other terms, the weight ratio of the first component (A) to the second component (B) is from 2:1 to 10:1.

The water-based epoxy resin is selected from the group consisting of epichlorohydrin-based epoxy resins, and glycidol ether-based epoxy resins, and combination thereof. In the preferred embodiment of the subject invention, the water-based epoxy resin is the reaction product of epichlorohydrin and a bisphenol, most preferably bisphenol A. However, in alternative embodiments of the subject invention, the water-based epoxy resin can be the reaction product of an alkene and peroxyacetic acid. The physical characteristics of the water-based epoxy resin of the second component (B), the amount of the water-based epoxy resin present in the second component (B), and the amount of the second component (B) present in the waterborne coating composition of the subject invention are all sufficient to enable the waterborne coating composition to produce the film to achieve the improved adhesion on the substrate as described below. A suitable water-based epoxy resin for the second component (B) is Beckopox® 384w/53WAMP which is commercially available from Solutia Inc. of St. Louis, Mo. under their Beckopox epoxy resin product line.

The waterborne coating composition of the subject invention may further include a binder-free, reduction agent (C) comprising water. As described above, once the binder-free, reduction agent (C) is introduced into the waterborne coating composition, the solvent-based polyurethane of the first component (A) becomes suitably dispersed in water due to the salt of the polyurethane, specifically due to the at least one carboxylate ion (COO⁻). The binder-free, reduction agent also reduces a viscosity of the first (A) and second (B) components to establish a reduced waterborne coating composition. The viscosity of the first (A) and second (B) components prior to addition of the binder-free, reduction agent (C) is 28″ measured with a #4 DIN cup @70-74° F., and after addition, the binder-free, reduction agent (C) reduces the viscosity to 11″ measured with a #4 DIN cup @70-74° F. for the reduced waterborne coating composition. To accomplish this, the binder-free, reduction agent (C) is present in an amount from 30 to 60, preferably from 40 to 50, parts by weight based on 100 parts by weight of the reduced waterborne coating composition. The binder-free, reduction agent (C) optionally includes a thickening agent to optimize application and processibility of the waterborne coating composition. In the preferred embodiment, the thickening agent is laponite.

In the context of the first component (A), the second component (B), and the binder-free, reduction agent (C), i.e., the reduced waterborne coating composition, the first component (A) is present in an amount from 30 to 60, preferably from 40 to 50, parts by weight based on 100 parts by weight of the reduced waterborne coating composition. In this same context, the second component (B) is present in an amount from 1 to 25, preferably from 5 to 15, parts by weight based on 100 parts by weight of the reduced waterborne coating composition.

The process for coating a substrate introduced in the subject method produces the film having improved adhesion and is characterized by using the waterborne coating composition set forth above. The process of producing the film of the waterborne coating composition includes the steps of providing the first component (A), neutralizing the at least one acid functional group of the polyurethane with the neutralizing agent, in the preferred embodiment the amine, and adding the second component (B) to the first component (A). This process also includes the step of reducing the viscosity of the first (A) and second (B) components with the binder-free, reduction agent (C) to establish the reduced waterborne coating composition. After the reduced waterborne coating composition is established, the reduced waterborne coating composition is applied on to the substrate. In the preferred embodiment of this process, the reduced waterborne coating composition is spray applied on to the substrate using air-atomized or rotary atomizing (i.e., bell) spray guns.

The time at which the second component (B) is added to the first component (A) can vary. That is, the second component (B) can be added after the waterborne coating composition is reduced at a time just prior to application of the reduced waterborne coating. This time for addition of the second component (B) is most likely ideal for users of the waterborne coating composition in the refinish coating industry. On the other hand, the second component (B) can be added directly to the first component (A) prior to the step of reducing the viscosity. As such, this time for addition of the second component (B) is most likely ideal for users of the waterborne coating composition in the OEM coating industry. In either industry, to make the waterborne coating composition of the subject invention, the first component (A) is measured and loaded into a loading vessel. Next, the second component (B) is measured and loaded into the loading vessel already having the first component (A). The first (A) and second (B) components are then stirred, either manually or automatically, and then the binder-free, reduction agent (C) is incorporated to achieve a desired viscosity specification for the waterborne coating composition. The binder-free, reduction agent (C) is also subject to stirring and/or other agitation.

In the preferred embodiment of the subject invention, the waterborne coating composition is a waterborne basecoat. After application of the waterborne basecoat on to the substrate, a clearcoat is applied over the waterborne basecoat. The clearcoat serves both aesthetic and functional purposes such as increasing gloss and resistance to acid-etch, respectively. It is to be understood that the clearcoat may be applied over the waterborne basecoat immediately, after a certain basecoat ‘flash’ period, or even after a pre-cure of the waterborne basecoat film. It is also to be understood that different types of clearcoats are compatible with the waterborne basecoat of the subject invention. These different types include, but are not limited to, one-component solventborne clearcoats, one-component waterborne clearcoats, two-component solventborne clearcoats, and two-component waterborne clearcoats. In the preferred embodiment, a two-component solventborne clearcoat is selected. The two-component solventborne clearcoat is activated by an isocyanate when the clearcoat is ready to be applied over the waterborne basecoat.

The improved adhesion of the film produced by the waterborne coating composition is from 0 to 10, preferably from 0 to 5, percent film loss according to the cross-hatch adhesion test. In the context of the subject invention, the cross-hatch adhesion test is defined as in the following description.

Prior to the actual cross-hatch adhesion test, two types of substrates are prepared. The first type of substrate, a C Panel, includes an electrocoat (e-coat) film, a primer film, and an OEM basecoat color film. The OEM basecoat color film can be a solventborne or a waterborne basecoat color film. The e-coat film, the primer film, and the OEM basecoat color film are deposited on the substrate by application techniques known in the art. Furthermore, the e-coat film, the primer film, and the OEM basecoat color film are cured on the substrate by cure techniques also known in the art. The exact application and cure techniques of the e-coat film, the primer film, and the OEM basecoat color film are not critical to the novelty of the subject invention so long as these techniques are considered sufficient to those skilled in the art. Next, the OEM basecoat color film is lightly sanded with #P400 sandpaper and cleaned to remove any sanding dust and to prepare the OEM basecoat color film for additional paint to be applied. The film of the waterborne coating composition is applied on to the substrate, over the e-coat film, the primer film, and the OEM basecoat color film, to hiding based on the color family of the waterborne coating composition. Preferably, the film of the waterborne coating composition is applied on to the substrate at from 0.4 to 0.7 mils. The film of the waterborne coating composition is allowed to flash between application coats from between 10 to 20 minutes. Then, the film of the waterborne coating composition is allowed to air dry for from 20 to 40 minutes after hiding is achieved. Next, a clearcoat is applied on to the film of the waterborne coating composition. More specifically, two application coats of clearcoat are applied with each coat being between 0.8-1.2 mils in thickness. Approximately five minutes of flash is desired between the two application coats. The clearcoat is then subject to air dry and cure for from 24 to 48 hours. After this period, the clearcoat is then baked for approximately 1 to 1½ hours at 60-80° C. The C Panel is intended to simulate what is known in the art as a “basecoat repair.”

The second type of substrate, a D Panel, is also prepared. As with the C Panel, the D Panel includes an electrocoat (e-coat) film, a primer film, an OEM basecoat color film, and an OEM clearcoat film. The OEM basecoat color film and the OEM clearcoat film can be solventborne or waterborne based. The entire D Panel, specifically the OEM clearcoat film, is sanded lightly with #P400 sandpaper preferably using an air-operated orbital sander. After sanding, the D Panel is cleaned with appropriate solvents to remove any sanding dust and to prepare the OEM clearcoat film for additional paint to be applied. After the D Panel is cleaned, masking paper is applied, or wrapped around, a top half of the substrate to mask off the top half of the D Panel. The film of the waterborne coating composition is then applied on to the substrate to hiding based on the color family of the waterborne coating composition. Preferably, the film of the waterborne coating composition is applied on to the substrate at from 0.4 to 0.7 mils. The film of the waterborne coating composition is allowed to flash between application coats from between 10 to 20 minutes. Then, the film of the waterborne coating composition is allowed to air dry for from 20 to 40 minutes after hiding is achieved. The masking paper is removed and a clearcoat is next applied. More specifically, two application coats of clearcoat are applied with each coat being between 0.8-1.2 mils in thickness. Approximately five minutes of flash is desired between the two application coats. The clearcoat is then subject to air dry and cure for from 24 to 48 hours. After this period, the clearcoat is then baked for approximately 1 to 1½ hours at 60-80° C. In sum, the top half of the D Panel now has e-coat film—primer film—OEM basecoat color film—OEM clearcoat film—sanding—clearcoat (refinish type), and the bottom half of the D Panel now has e-coat film—primer film—OEM basecoat color film—OEM clearcoat film—sanding—waterborne basecoat film—clearcoat (refinish type). The D Panel is intended to simulate what is known in the art as a “clearcoat repair.”

After the C and D Panel substrates are prepared, the substrates are then prepared for the cross-hatch adhesion test. The cross-hatch adhesion test, as defined herein, can also be found in General Motors Engineering Standard GM9071P (September 1997), entitled “Tape Adhesion Test For Paint Finishes,” 5.1 Cross Hatch Tape Test (Method A) (hereinafter referred to as Cross-Hatch Adhesion Test 1), and in Ford Laboratory Test Method BI 106-01, entitled “Paint Adhesion Test,” Method “B”—Scribe Test (hereinafter referred to as Cross-Hatch Adhesion Test 2). As the above description indicates, the terminology “cross-hatch” as used herein is intended to be generic. For example, the Cross-hatch Adhesion Test 2, also referred to as a Method “B”—Scribe Test is, for purposes of the subject invention, a suitable cross-hatch adhesion test. The waterborne coating composition of the subject invention producing the film having from 0 to 10, and preferably from 0 to 5, percent film loss achieves these percent film loss values under both Cross-Hatch Adhesion Tests 1 and 2. Such percent film losses under both Cross-Hatch Adhesion test 1 and 2 are unexpected for waterborne coating compositions.

Under Cross-Hatch Adhesion Test 1, a 6×6 cross-cut is made into the film on the substrate using a specialized 6-edge cutting tool known in the art. Ultimately, the 6×6 cross-cut has a checker board-type pattern. Each cut of the 6×6 cross-cut is spaced approximately 1 mm apart. Next, any residue resulting from the 6×6 cross-cut is removed, i.e., brushed, from the substrate, and an adhesive tape is applied to the 6×6 cross-cut made into the film. The adhesive tape is rubbed to ensure that any air that is trapped between the adhesive tape and the film is eliminated. Finally, an end of the adhesive tape is grasped between a thumb and a forefinger of an operator, and the adhesive tape is rapidly pulled upwardly perpendicular from the film. The preferred adhesive tape bonds to steel with a 180° peel strength value of at least 430 N/m.

After the adhesive tape is pulled from the film on the substrate, the cross-hatch adhesion of the film is visually evaluated by the operator looking at both the amount of film, if any, on the adhesive tape, and the amount of film, if any, on the substrate. Ultimately, the objective is to determine the percent of film loss from the substrate. Under Cross-Hatch Adhesion Test 1, the visual evaluation by the operator is represented according to a scale from 0 to 100, with 0 being perfect, i.e., 0 percent film loss from the substrate, and with 100 being total film failure, i.e., 100 percent film loss from the substrate.

Under Cross-Hatch Adhesion Test 2, an approximately 9×9 cross-cut is made into the film using a carbide-tipped scriber and a template, both tools that are known in the art. Ultimately, the 9×9 cross-cut has a checker board-type pattern. In addition to the 9×9 cross-cut, approximately 15 additional diagonally extending lines are scribed at equal distances across the 9×9 cross-cut. Each cut of the 9×9 cross-cut is spaced approximately 3 mm apart. Next, any residue resulting from the 9×9 cross-cut is removed, i.e., brushed, from the substrate, and an adhesive tape is applied to the 9×9 cross-cut made into the film. The adhesive tape is rubbed to ensure that any air that is trapped between the adhesive tape and the film is eliminated. Finally, an end of the adhesive tape is grasped between a thumb and a forefinger of an operator, and the adhesive tape is rapidly pulled upwardly perpendicular from the film. The preferred adhesive tape is Adhesion Tape No. 898 commercially available from 3M.

After the adhesive tape is pulled from the film on the substrate, the cross-hatch adhesion of the film is visually evaluated by the operator looking at both the amount of film, if any, on the adhesive tape, and the amount of film, if any, on the substrate. Ultimately, the objective is to determine the percent of film loss from the substrate. Under Cross-Hatch Adhesion Test 2, the visual evaluation by the operator is represented according to a scale from 0 to 100, with 0 being perfect, i.e., 0 percent film loss from the substrate, and with 100 being total film failure, i.e., 100 percent film loss from the substrate.

The waterborne coating composition of the subject invention also produces the film to have improved adhesion on the substrate of from 0 to 5 percent film loss according to a X-scribe adhesion test. The X-scribe adhesion test, as defined herein, can also be found in General Motors Engineering Standard GM9071P (September 1997), entitled “Tape Adhesion Test For Paint Finishes,” 5.2 Cross Cut Tape Test (Method B) (hereinafter referred to as Cross-Cut Adhesion Test 3). The waterborne coating composition of the subject invention producing the film having from 0 to 5 percent film loss achieves this percent film loss value under Cross-Cut Adhesion Test 3.

Under Cross-Cut Adhesion Test 3, an “X” cut, consisting of two bisecting lines each approximately 75 mm long, is made into the film using a sharp pointed razor knife or a razor blade. During cutting, the razor knife or razor blade is held perpendicular to the substrate. Next, any residue resulting from the “X” cut is removed, i.e., brushed, from the substrate, and an adhesive tape is applied to the “X” cut. Specifically, the “X” cut is covered with the adhesive tape such that the adhesive tape is centered over an intersection of the two lines and such that the adhesive tape extends for at least 38 mm on both sides of the intersection. Also, part of the adhesive tape should remain for grasping. The adhesive tape is rubbed to ensure that any air that is trapped between the adhesive tape and the film is eliminated. Finally, an end of the adhesive tape is grasped between a thumb and a forefinger of an operator, and the adhesive tape is rapidly pulled upwardly perpendicular from the film. The preferred adhesive tape bonds to steel with a 180° peel strength value of at least 430 N/m.

After the adhesive tape is pulled from the film on the substrate, the X-scribe adhesion of the film is visually evaluated by the operator looking at both the amount of film, if any, on the adhesive tape, and the amount of film, if any, on the substrate. Ultimately, the objective is to determine the percent of film loss from the substrate. Under Cross-Cut Adhesion Test 3, the visual evaluation by the operator is represented according to a scale from 0 to 100, with 0 being total film failure, i.e., 100 percent film loss from the substrate, and with 100 being perfect, i.e., 0 percent film loss from the substrate.

The waterborne coating composition of the subject invention also produces the film to have improved adhesion on the substrate even after the film is subjected to humidity. More specifically, the film has improved adhesion on the substrate of from 0 to 10, preferably from 0 to 5, percent film loss according to Cross-Hatch Adhesion Test 1 after the film on the substrate is subjected to 100% relative humidity at 100° F. for at least 96 hours.

The waterborne coating composition of the subject invention also produces a film to having improved adhesion on the substrate even after the film is subjected to water immersion. More specifically, the film has improved adhesion on the substrate of from 0 to 50, preferably from 0 to 30, percent film loss according to Cross-Hatch Adhesion Test 2 after the film on the substrate is immersed in water at 32° C. for at least 10 days.

The following examples, illustrating the formation of the waterborne coating composition according to the subject invention and illustrating certain properties of the waterborne coating composition and of the film produced by the waterborne coating composition as applied on to the substrate, as presented herein, are intended to illustrate and not limit the invention.

### EXAMPLES

The waterborne coating composition was prepared by adding and reacting the following parts, by weight, unless otherwise indicated.

TABLE 1
Various Waterborne Coating Composition Examples
[varying levels of the second component (B) and of the water-based
epoxy resin]

| Waterborne | | | | | | |
|---|---|---|---|---|---|---|
| Coating | | | | | | |
| Composition | | Ex. | Ex. | Ex. | Ex. | Ex. |
| Component | Detail | 1 | 2 | 3 | 4 | 5 |
| First | 39.6% of first | 100 | 100 | 100 | 100 | 100 |
| Component | component (A) | | | | | |
| (A) | is solvent-based | | | | | |
| | polyurethane | | | | | |
| Second | 45.9% of second | 0 | 10 | 15 | 20 | 40 |
| Component | component (B) | | | | | |
| (B) | is water-based | | | | | |
| | epoxy resin | | | | | |
| Binder Free, | 97.5% water | 100 | 100 | 100 | 100 | 100 |
| Reduction Agent | | | | | | |
| (C) | | | | | | |

Example 1 operates as the control as 0 parts of the second component (B) are incorporated into the waterborne coating composition. Examples 2 through 5 have increasing amounts of the second component (B), and specifically of the water-based epoxy resin, relative to the first component (A). Example 2 has 10 parts of the second component (B), Example 3 has 15 parts of the second component (B), Example 4 has 20 parts of the second component (B), and Example 5 has 40 parts of the second component (B).

The initial Adhesion for these Examples according to Cross-Cut Adhesion Test 3 and Cross-Hatch Adhesion Test 1 are shown in Table 2 below.

TABLE 2
Initial Adhesion

| | | Cross-Cut | | Cross-Hatch | |
|---|---|---|---|---|---|
| | | Adhesion Test 3 | | Adhesion Test 1 | |
| | Substrate | C Panel | D Panel | C Panel | D Panel |
| | Preparation | Substrate | Substrate | Substrate | Substrate |
| Ex. 1 | Top | 100 | 100 | 0 | 0 |
| | Bottom | 100 | 100 | 0 | 0 |
| Ex. 2 | Top | 100 | 100 | 0 | 0 |
| | Bottom | 100 | 100 | 0 | 0 |
| Ex. 3 | Top | | | | |
| | Bottom | | | | |
| Ex. 4 | Top | 100 | 100 | 0 | 0 |
| | Bottom | 100 | 100 | 0 | 30 |
| Ex. 5 | Top | 100 | 100 | 0 | 0 |
| | Bottom | 100 | 100 | 0 | 50 |

Key:
Cross Cut Adhesion Test 3
0 = Total Film Failure→ 100% film loss from substrate
100 = No Film Failure→ 0% film loss from substrate
Cross-Hatch Adhesion Test 1
0 = No Film Failure→ 0% film loss from substrate
100 = Total Film Failure→ 100% film loss from substrate

Example 3 was not subjected to Cross-Cut Adhesion Test 3 and Cross-Hatch Adhesion Test 1. Also, for the C Panel substrate, there was no difference between the top and bottom of the panel substrate because the top and bottom were prepared identically as described above. Recall that for the D panel substrate, the top of the panel substrate was prepared to have e-coat film—primer film—OEM basecoat color film—OEM clearcoat film—sanding—clearcoat (refinish type). On the other hand, the bottom of the panel substrate was prepared to have e-coat film—primer film—OEM basecoat color film—OEM clearcoat film—sanding—waterborne basecoat film—clearcoat (refinish type).

In summary, the results set forth in Table 2 disclose that Examples 1 through 5 generally exhibit adequate initial adhesion under both the Cross-Cut Adhesion Test 3 and Cross-Hatch Adhesion Test 1.

The adhesion after 100% relative humidity at 100° F. for 96 hours for these Examples according to Cross-Cut Adhesion Test 3 and Cross-Hatch Adhesion Test 1 are shown in Table 3 below. Subjecting these Examples to the Cross-Cut Adhesion Test 3 and the Cross-hatch Adhesion Test 1, after exposure of the substrate to humidity, demonstrates the improved adhesion of the film and that the film is resistant to water-related defects, including the water-related defect of poor adhesion of the film on the substrate.

TABLE 3
Adhesion After Humidity
Adhesion After 100% Relative Humidity @ 100° F. For 96 Hours

| | | Cross-Cut | | Cross-Hatch | |
|---|---|---|---|---|---|
| | | Adhesion Test 3 | | Adhesion Test 1 | |
| | Substrate | C Panel | D Panel | C Panel | D Panel |
| | Preparation | Substrate | Substrate | Substrate | Substrate |
| Ex. 1 | Top | 25 | 50 | 100 | 50 |
| | Bottom | 25 | 50 | 100 | 100 |
| Ex. 2 | Top | 100 | 100 | 60 | 0 |
| | Bottom | 100 | 100 | 60 | 0 |
| Ex. 3 | Top | | | | |
| | Bottom | | | | |
| Ex. 4 | Top | 100 | 100 | 0 | 0 |
| | Bottom | 100 | 100 | 0 | 0 |
| Ex. 5 | Top | 100 | 100 | 0 | 0 |
| | Bottom | 100 | 100 | 0 | 0 |

Key:
Cross Cut Adhesion Test 3
0 = Total Film Failure→ 100% film loss from substrate
100 = No Film Failure→ 0% film loss from substrate
Cross Hatch Adhesion Test 1
0 = No Film Failure→ 0% film loss from substrate
100 = Total Film Failure→ 100% film loss from substrate

Example 3 was not subjected to Cross-Cut Adhesion Test 3 and Cross-Hatch Adhesion Test 1 after humidity. Also, for the C Panel substrate, there was no difference between the top and bottom of the panel substrate because the top and bottom were prepared identically as described above.

Under Cross-Cut Adhesion Test 3, the C Panel substrate for Example 1, the control with no second component (B), i.e., with no water-based epoxy resin, exhibited unacceptable adhesion results. More specifically, the C Panel substrate for Example 1 had 75% film loss from the substrate. Furthermore, the D Panel substrate for the control Example 1 had 50% film loss from the substrate on the bottom of the substrate. On the other hand, Examples 2 through 5 having increasing amounts of the second component (B), exhibited no film failure, i.e., 0% film loss from the substrate, for both the C and D Panel substrates.

Under Cross-Hatch Adhesion Test 1, the C Panel substrate for the control Example 1 had unacceptable adhesion results exhibiting 100% film loss from the substrate. A marginally improved adhesion was achieved with the waterborne coating composition of Example 2, having 10 parts of the second component (B) relative to 100 parts of the first component (A). Furthermore, Examples 3 through 5 having increasing amounts of the second component (B) exhibited no film failure.

The initial Adhesion and the adhesion after immersion in water at 32° C. for 10 days for Examples 1, 3 and 4 according to Cross-Hatch Adhesion Test 2 are shown in Table 4 below.

TABLE 4
Adhesion After Water Immersion

| | | | | Adhesion After | |
|---|---|---|---|---|---|
| | | | | Immersed in Water at | |
| | | Initial Adhesion | | 32° C. For 10 Days | |
| | | Cross-Hatch Adhesion | | Cross-Hatch Adhesion | |
| | | Test 2 | | Test 2 | |
| | Substrate | C Panel | D Panel | C Panel | D Panel |
| | Preparation | Substrate | Substrate | Substrate | Substrate |
| Ex. 1 | Top | 15 | 40 | 70 | 100 |
| | Bottom | 15 | 40 | 70 | 100 |
| Ex. 3 | Top | 0 | 0 | 10 | 10 |
| | Bottom | 0 | 0 | 10 | 0 |
| Ex. 4 | Top | 0 | 0 | 15 | 30 |
| | Bottom | 0 | 0 | 15 | 0 |

Key:
Cross-Hatch Adhesion Test 2
0 = No Film Failure→ 0% film loss from substrate
100 = Total Film Failure→ 100% film loss from substrate

For the C Panel substrate, there is no difference between the top and bottom of the panel substrate because the top and bottom were prepared identically as described above.

Under Cross-Cut Adhesion Test 2, the C Panel substrate for Example 1, the control with no second component (B), i.e., with no water-based epoxy resin, exhibited unacceptable adhesion results relative to Examples 3 and 4 for initial adhesion. More specifically, the C and D Panel substrates had 15 and 40% film loss from the substrate, respectively. On the other hand, Examples 3 and 4, for both the C and D Panel substrates exhibited no film failure, i.e., 0% film loss from the substrate.

Under Cross-Hatch Adhesion Test 2 for adhesion after the C and D Panel substrates were immersed in water at 32° C. for 10 days, Example 1, the control, had unacceptable adhesion results exhibiting 70 and 100% film loss from the substrate. On the other hand, Examples 3 and 4, having increasing amounts of the second component (B), had improved adhesion relative to the Example 1 ranging from only 0 to 30% film loss from the substrate.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

What is claimed is:

1. A waterborne coating composition producing a film having improved adhesion on a substrate, said coating composition comprising:
(A) a first component comprising a solvent-based polyurethane and a neutralizing agent, said polyurethane including at least one hydroxyl functional group and at least one acid functional group wherein said at least one acid functional group of said polyurethane is neutralized by said neutralizing agent to form an ammonium ion and a salt of said polyurethane having at least one carboxylate ion, said salt of said polyurethane establishing dispersibility of said polyurethane in water; and
(B) a second component comprising a water-based epoxy resin substantially free of co-solvents and including at least one epoxide group reactive with said ammonium ion of said first component (A);
wherein said first (A) and second (B) components of said waterborne coating composition produce the film having improved adhesion on the substrate of from 0 to 10 percent film loss according to a cross-hatch adhesion test.

2. A waterborne coating composition as set forth in claim 1 wherein said polyurethane of said first component (A) includes a number-average molecular weight of from 1,000 to 30,000.

3. A waterborne coating composition as set forth in claim 1 wherein said polyurethane of said first component (A) includes a hydroxyl number of from 10 to 200 mg KOH/g.

4. A waterborne coating composition as set forth in claim 1 wherein said polyurethane of said first component (A) includes an acid number of from 5 to 150 mg KOH/g.

5. A waterborne coating composition as set forth in claim 1 wherein said polyurethane of said first component (A) includes a weight-average molecular weight of from 5,000 to 50,000.

6. A waterborne coating composition as set forth in claim 1 wherein said neutralizing agent of said first component (A) further comprises an amine.

7. A waterborne coating composition as set forth in claim 1 further comprising (C) a binder-free, reduction agent comprising water that reduces a viscosity of said first (A) and second (B) components to establish a reduced waterborne coating composition.

8. A waterborne coating composition as set forth in claim 7 wherein said binder-free, reduction agent (C) further comprises a thickening agent.

9. A waterborne coating composition as set forth in claim 7 wherein said first component (A) is present in an amount from 30 to 60 parts by weight based on 100 parts by weight of said reduced waterborne coating composition.

10. A waterborne coating composition as set forth in claim 7 wherein said second component (B) is present in an amount from 1 to 25 parts by weight based on 100 parts by weight of said reduced waterborne coating composition.

11. A waterborne coating composition as set forth in claim 7 wherein said binder-free, reduction agent (C) is present in an amount from 30 to 60 parts by weight based on 100 parts by weight of said reduced waterborne coating composition.

12. A waterborne coating composition as set forth in claim 1 wherein said water-based epoxy resin of said second component (B) includes an epoxy equivalent weight of from 500 to 1500 g/mol according to DIN 53188.

13. A waterborne coating composition as set forth in claim 1 wherein said water-based epoxy resin of said second component (B) includes a number-average molecular weight of from 500 to 3,000.

14. A waterborne coating composition as set forth in claim 1 wherein said water-based epoxy resin of said second component (B) is selected from the group consisting of epicholorhydrin-based epoxy resins, and glycidol ether-based epoxy resins, and combination thereof.

15. A waterborne coating composition as set forth in claim 1 wherein said water-based epoxy resin of said second component (B) is the reaction product of epichlorohydrin and bisphenol A.

16. A waterborne coating composition as set forth in claim 1 wherein said water-based epoxy resin of said second component (B) is the reaction product of an alkene and peroxyacetic acid.

17. A waterborne coating composition as set forth in claim 1 wherein said second component (B) is present in an amount from 10 to 50 parts by weight based on 100 parts by weight of said first component (A).

18. A waterborne coating composition as set forth in claim 1 wherein said second component (B) further comprises a surfactant to establish dispersibility of said epoxy resin in water without use of co-solvents.

19. A waterborne coating composition as set forth in claim 1 wherein said polyurethane is present in said first component (A) in an amount from 15 to 50 parts by weight based on 100 parts by weight of said first component (A).

20. A waterborne coating composition as set forth in claim 1 wherein said first component (A) further comprises at least one organic, water-dilutable solvent present in an amount from 30 to 60 parts by weight based on 100 parts by weight of said first component (A).

21. A waterborne coating composition as set forth in claim 1 wherein said first component (A) further comprises at least one pigment present in an amount from 5 to 50 parts by weight based on 100 parts by weight of said first component (A).

22. A waterborne coating composition as set forth in claim 1 wherein said first component (A) further comprises at least one additive selected from the group consisting of surfactants, fillers, catalysts, flow and appearance control agents, rheology control additives, UV-resistant additives, defoaming additives, and combinations thereof.

23. A waterborne coating composition as set forth in claim 1 wherein said first (A) and second (B) components of said waterborne coating composition produce the film having improved adhesion on the substrate of from 0 to 5 percent film loss according to a X-scribe adhesion test.

24. A waterborne coating composition as set forth in claim 1 wherein said first (A) and second (B) components of said waterborne coating composition produce the film having improved adhesion on the substrate of from 0 to 10 percent film loss according to a cross-hatch adhesion test after the film is subjected to 100% relative humidity at 100° F. for at least 96 hours.

25. A waterborne coating composition as set forth in claim 1 wherein said first (A) and second (B) components of said waterborne coating composition produce the film having improved adhesion on the substrate of from 0 to 50 percent film loss according to a cross-hatch adhesion test after the film is immersed in water at 32° C. for at least 10 days.

26. A waterborne coating composition as set forth in claim 1 further comprising an ester formed by a reaction between a hydrogen atom of said ammonium ion and said at least one epoxide group of said water-based epoxy resin.

27. A process for coating a substrate to produce a film having improved adhesion to the substrate, said process characterized by applying to a substrate, the waterborne coating composition as set forth in claim 1.

28. A substrate having a film thereon produced by the waterborne coating composition set forth in claim 1.

29. A substrate as set forth in claim 28 wherein said film has an improved adhesion of from 0 to 10 percent film loss according to the cross-hatch adhesion test.

30. A process of producing a film of a waterborne coating composition having improved adhesion on a substrate, said process comprising the steps of:
providing a first component comprising a solvent-based polyurethane and a neutralizing agent wherein the polyurethane includes at least one hydroxyl functional group and at least one acid functional group;
neutralizing the at least one acid functional group of the polyurethane with the neutralizing agent thereby forming an ammonium ion and a salt of the polyurethane having at least one carboxylate ion wherein the salt establishes dispersibility of the polyurethane in water; and
adding a second component to the first component wherein the second component a water-based epoxy resin substantially free of co-solvents and including at least one epoxide group reactive with the ammonium ion of the first component;
applying a waterborne coating comprising the first and second component to a substrate;
wherein the first and second components of the waterborne coating composition provide a film having improved adhesion on the substrate, demonstrated by film loss of from 0 to 10 percent, according to a cross-hatch adhesion test.

31. A process as set forth in claim 30 further including the step of reducing a viscosity of the first and second components with a binder-free, reduction agent that comprises water thereby establishing a reduced waterborne coating composition.

32. A process as set forth in claim 31 wherein the step of applying the reduced waterborne coating composition is further defined as spraying the reduced waterborne coating composition on to the substrate.

33. A process as set forth in claim 31 wherein the step of adding the second component to the first component is further defined as adding the second component after the step of reducing the viscosity and prior to the step of applying the reduced waterborne coating composition.

34. A process as set forth in claim 31 wherein the step of adding the second component to the first component is further defined as adding the second component prior to the step of reducing the viscosity.
